(19) United States
(12) Patent Application Publication
(10) Pub. No.: US 2026/0125005 A1
(43) Pub. Date: May 7, 2026

(54) Sleeve Assembly for Wiring Harness Installation

(71) Applicant: Aptiv Technologies AG, Schaffhausen (CH)

(72) Inventors: Jeffrey Michael, Austintown, OH (US); Ryan Lewis, Niles, OH (US); Robert Dean, New Castle, PA (US); Jared Bilas, North Bloomfield, OH (US); Joseph Sudik, JR., Niles, OH (US); David R. Peterson, Aurora, OH (US)

(21) Appl. No.: 18/934,406

(22) Filed: Nov. 1, 2024

(51) Int. Cl. B60R 16/02; H02G 3/34

(52) U.S. Cl. CPC B60R 16/0215; H02G 3/34

(57) ABSTRACT

An end cap for a wiring harness installation sleeve includes a base, a first portion, and a second portion. The base is disposed around a central axis and includes a first end and a second end opposite the first end. The first portion extends from the first end and is disposed about the central axis. The first portion includes an outer surface. The second portion extends from the first end and is disposed about the central axis. The second portion includes an inner surface. The inner surface and the outer surface define a gap configured to receive the wiring harness installation sleeve.

### FIELD

The present disclosure relates to systems for installing wiring harnesses and more particularly to a sleeve assembly for wiring harness installation.

### BACKGROUND

Modern vehicles (e.g., automobiles) rely on electrical wiring and electrical connections to facilitate the transmission of electricity within, and between various components of, the vehicle. Wiring harnesses (e.g., connectors and bundles of wires) play an important role in ensuring the integrity of these electrical connections and the reliability and performance of the vehicle. Wiring harness often lack the structural integrity (e.g., rigidity) to ensure the accurate and repeatable handling, positioning, and securement of the wiring harnesses and/or other components during an assembly process. Often, these wiring harnesses require manual installation or complex tooling to install, which can increase the cost and complexity of the wiring harnesses. For example, the wiring harnesses may be placed inside another component (e.g., a sleeve) to provide the rigidity necessary to install the wiring harness automatically/robotically. These components are often costly and complex. In view of the foregoing, while known systems and methods for installing wiring harnesses have proven acceptable for their intended purpose, a continuous need for improvement remains in the pertinent art to address the challenges associated with accurate and efficient assembly of the wiring harnesses.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

One aspect of the disclosure provides an end cap for a wiring harness installation sleeve. The end cap includes a base, a first portion, and a second portion. The base is disposed around a central axis and includes a first end and a second end opposite the first end. The first portion extends from the first end and is disposed about the central axis. The first portion includes an outer surface. The second portion extends from the first end and is disposed about the central axis. The second portion includes an inner surface. The inner surface and the outer surface define a gap configured to receive the wiring harness installation sleeve.

Another aspect of the disclosure provides a wiring harness installation sleeve. The wiring harness installation sleeve includes a first surface and a second surface. The first surface extends from a first end of the sleeve to a second end of the sleeve. The second surface is opposite the first surface and extends from the first end to the second end. The second surface defines at least one recess disposed between the first end and the second end and configured to facilitate bending the sleeve in a first direction.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The present disclosure will become more fully understood from the detailed description and the accompanying drawings.

FIG. 1 is a perspective view of a wiring harness installation assembly in accordance with the principles of the present disclosure.

FIG. 2 is an exploded view of the wiring harness installation assembly of FIG. 1 in accordance with the principles of the present disclosure.

FIG. 3 is a cross-sectional view of the wiring harness installation assembly of FIG. 1 taken through the line A-A in accordance with the principles of the present disclosure.

FIG. 4 is a perspective view of a tool manipulating a wiring harness installation assembly in accordance with the principles of the present disclosure.

FIG. 5 is a perspective view of a sleeve of a wiring harness installation assembly in accordance with the principles of the present disclosure.

FIG. 6 is a perspective view of a first endcap of a wiring harness installation assembly in accordance with the principles of the present disclosure.

FIG. 7 is a perspective view of a second endcap of a wiring harness installation assembly in accordance with the principles of the present disclosure.

In the drawings, reference numbers may be reused to identify similar and/or identical elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

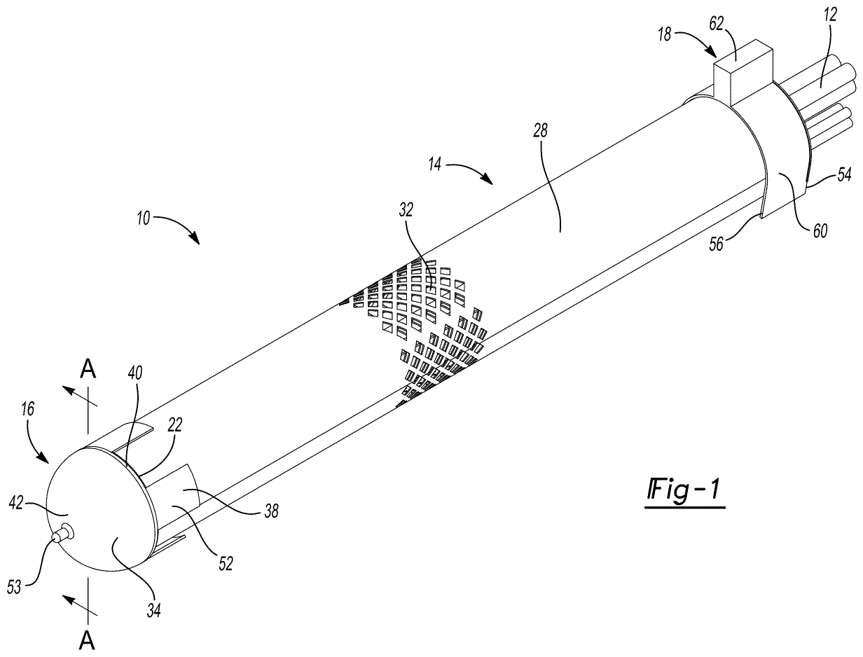

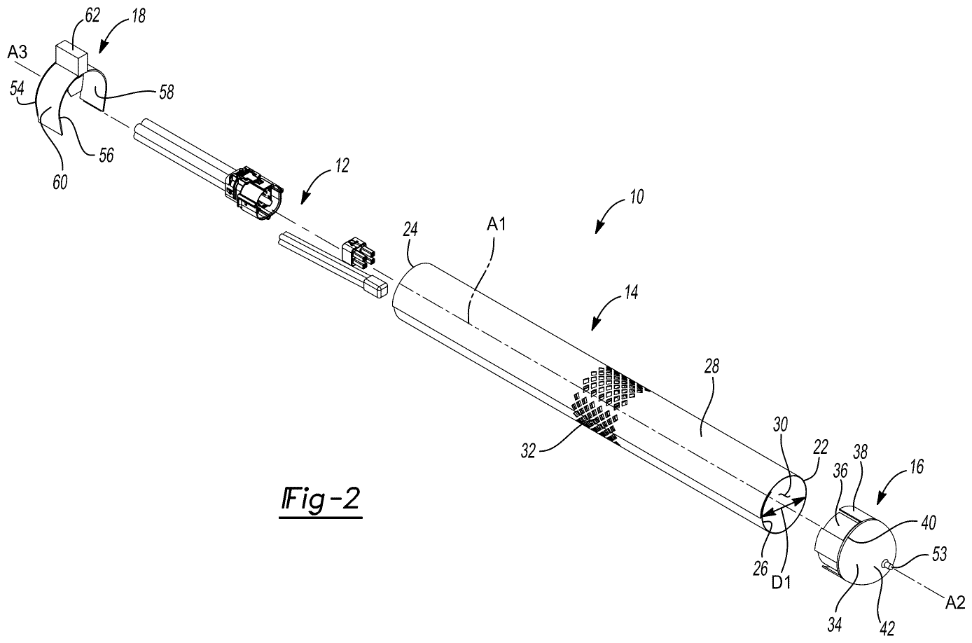

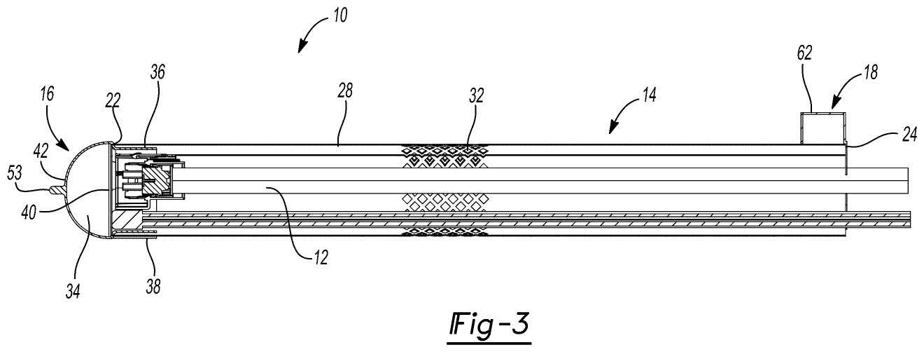

With reference to FIGS. 1-3, a wiring harness installation assembly 10 is illustrated. As will be explained in more detail below, the wiring harness installation assembly 10 may be used during installation of a wiring harness 12. In particular, the wiring harness installation assembly 10 may be used during installation of a wiring harness 12 into a vehicle (not shown), such as an automobile.

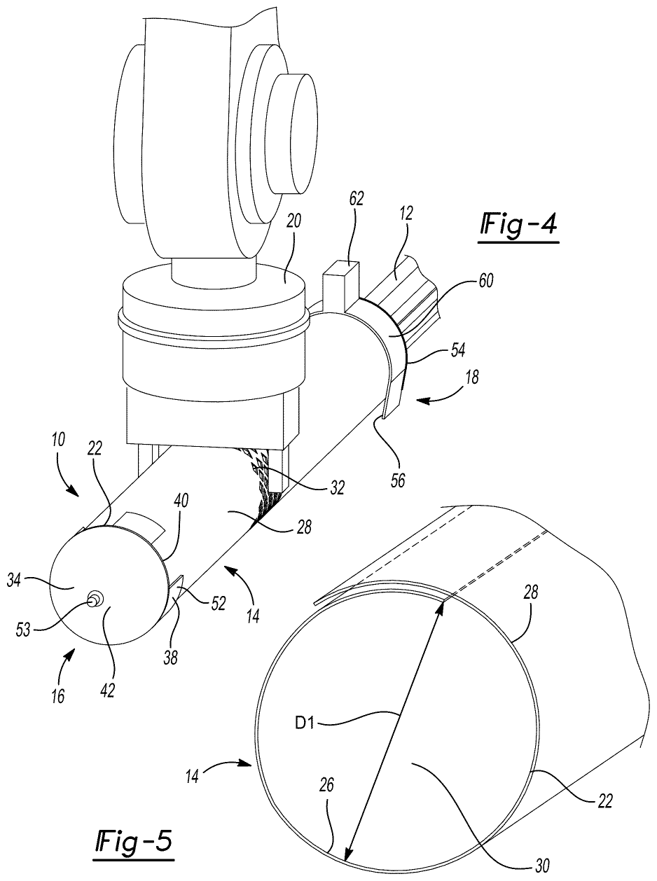

The wiring harness installation assembly 10 may include a sleeve 14, a first endcap 16, and a second endcap 18. In some implementations, the wiring harness 12 is disposed within one or more of the sleeve 14, the first endcap 16, and/or the second endcap 18 during a method of assembling the wire harness 12 into a vehicle or other assembly. In this regard, during a method of assembling the wire harness 12 into a vehicle or other assembly, the wiring harness installation assembly 10 may be manipulated by a tool 20 (FIG. 4) that may be sized and/or shaped to engage the wiring harness installation assembly 10 (e.g., the sleeve 14, the first endcap 16, and/or the second endcap 18). In some implementations, the tool 20 may be a robotic arm or an end effector located at an end of the robotic arm.

With reference to FIGS. 1-3 and 5, the sleeve 14 may include a first end 22, a second end 24, a first surface 26, and a second surface 28. The second end 24 may be opposite the first end 22. The first surface 26 may extend from the first end 22 to the second end 24. The second surface 28 may be opposite the first surface 26 and extend from the first end 22 to the second end 24. In some implementations, the sleeve 14 is formed of a rigid or semi-rigid material. For example, the sleeve 14 may be formed from a polymer such as acrylonitrile butadiene styrene (ABS), polyvinyl chloride (PVC), or any other suitable material.

The first surface 26 and/or the second surface 28 may be disposed (e.g., circumferentially-disposed) around a first axis A1. The first surface 26 and/or the second surface 28 may define a conduit 30 (e.g., a hollow cylinder). In this regard, the first surface 26 may be an inner surface, and the second surface 28 may be an outer surface. In some implementations, the first surface 26 and the second surface 28 collectively define the conduit 30. For example, the first surface 26 or the second surface 28 may at least partially overlap the other of the first surface 26 or the second surface 28 such that the sleeve 14 defines a first cross-sectional dimension (e.g., diameter) D1. The first cross-sectional dimension D1 may be adjustable based on the amount of overlap between the first surface 26 and the second surface 28.

Prior to forming the conduit 30, the sleeve 14 may define a substantially flat sheet. In the assembled configuration, the sleeve 14 may form the conduit 30 that is wrapped around the wiring harness 12. After installing the wiring harness 12, the sleeve 14 may be removed (e.g., unwrapped) from around the wiring harness 12. The sleeve 14 may allow for efficient and secure placement of the wiring harness 12 within the sleeve 14. Additionally, the conduit 30 configuration of the sleeve 14 may allow the sleeve 14 to work with wiring harnesses (e.g., the wiring harness 12) of varying sizes (e.g., diameters or other cross-sectional dimensions).

The second surface 28 may define one or more recesses 32. The recesses 32 may be disposed between the first end 22 and the second end 24 of the sleeve 14. In some implementations, the recesses 32 may extend through the first surface 26. The recesses 32 may facilitate bending (e.g., by the tool 20) the sleeve 14 in one or more directions. For example, the tool 20 may engage the sleeve 14 and/or the endcaps 16, 18 and manipulate (e.g., bend) the sleeve 14 during installation of the wiring harness installation assembly 10. In this regard, the recesses 32 may reduce the rigidity of the sleeve 14 at the location of the recesses 32, thereby making it easier to bend the sleeve 14. In some implementations, the one or more recesses 32 includes a plurality of recesses 32. The plurality of recesses 32 may collectively surround the sleeve 14. For example, the plurality of recesses 32 may be equally spaced around at least a portion of the sleeve 14. In some implementations, the sleeve 14 includes multiple groups of recesses 32 located at different locations on the sleeve 14. In some implementations, each recess 32 of the recesses 32 has the same shape. For example, each recess 32 may have a diamond shape.

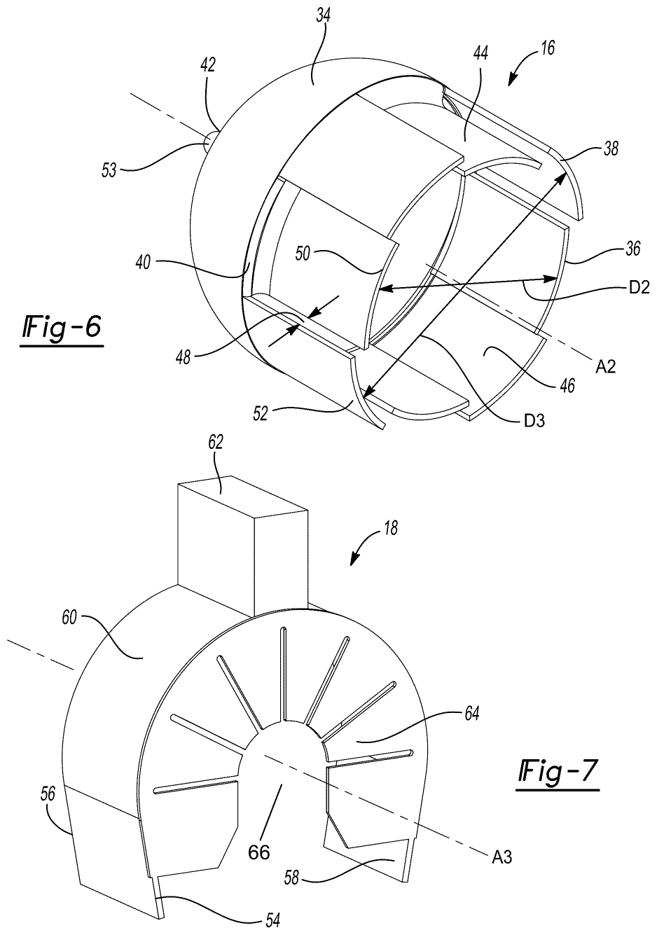

With reference to FIG. 6, the first endcap 16 may include a base 34, a first portion 36, and a second portion 38. In some implementations, the base 34 forms a semi-spherical shape disposed around a second axis A2. The base 34 may include a first end 40 and a second end 42 opposite the first end 40. In an assembled configuration of the wiring harness installation assembly 10, the second axis A2 may be coaxial with the first axis A1. In this regard, the first portion 36 may be concentric with the second portion 38.

The first portion 36 may extend from the first end 40 and be disposed around the second axis A2. The second portion 38 may extend from the first end 40 and be disposed around the second axis A2. The first portion 36 may include an outer surface 44, and the second portion 38 may include an inner surface 46. The inner surface 46 may face the outer surface 44.

The first portion 36 (e.g., the outer surface 44) may collectively define a second cross-sectional dimension (e.g., diameter) D2, and the second portion 38 (e.g., the inner surface 46) may collectively define a third cross-sectional dimension (e.g., diameter) D3. The third cross-sectional dimension D3 may be larger or smaller than the second cross-sectional dimension D2. Accordingly, in some implementations, the inner surface 46 and the outer surface 44 may define a gap 48 therebetween. In this regard, the gap 48 may be the difference between the third cross-sectional dimension D3 and the second cross-sectional dimension D2.

In an assembled configuration (FIG. 1), the sleeve 14 may be disposed within the gap 48. In the assembled configuration, the sleeve 14 (e.g., the second surface 28) may engage the inner surface 46. In some implementations, the sleeve (e.g., the first surface 26 and/or the second surface 28) may engage the outer surface 44. In the assembled configuration, the first end 22 of the sleeve 14 may engage the first end 40 of the base 34. In this regard, the first endcap 16 (e.g., the third cross-sectional dimension D3 and/or the second cross-sectional dimension D2) may control the size of the sleeve 14 (e.g., the first cross-sectional dimension D1). In some implementations, the first endcap 16 is secured to the first end 22 of the sleeve 14 using an adhesive.

The first portion 36 may include a set of first fingers 50 disposed around the second axis A2 and the second portion 38 may include a set of second fingers 52 disposed around the second axis A2. The set of first fingers 50 may be equally spaced around the base 34. The set of second fingers 52 may be equally spaced around the base 34. In some implementations, the set of first fingers 50 and the set of second fingers 52 are disposed around the second axis A2 in an alternating pattern. For example, each finger 50 of the set of first fingers 50 may be disposed between two fingers 52 of the set of second fingers 52, and each finger 52 of the set of second fingers 52 may be disposed between two fingers 50 of the set of first fingers 50. Each first finger 50 and/or each second finger 52 may have a curved rectangular shape. In this regard, each first finger 50 and/or each second finger 52 may form a portion of a thin-walled cylinder.

As illustrated in FIG. 6, the base 34 may include a robotic installation feature 53. In some implementations, the robotic installation feature 53 extends from the second end 42 of the base 34. The robotic installation feature 53 may form a protrusion (e.g., a nipple) configured for manipulation (e.g., the tool 20 or another tool) during installation of the wiring harness installation assembly 10.

The size of the first endcap 16 may be dependent on the size of the wiring harness 12. The first endcap 16 may be plastic, such as ABS or PVC, or any other suitable material. While the first endcap 16 is generally shown and described as engaging the first end 22 of the sleeve 14, the first endcap 16 may engage the second end 24 of the sleeve 14 within the scope of the present disclosure.

With reference to FIG. 7, the second endcap 18 may include a first end 54, a second end 56, an inner surface 58, and an outer surface 60. The second end 56 may be opposite the first end 54. The inner surface 58 may extend between the first end 54 and the second end 56. The outer surface 60 may be opposite the inner surface 58 and extend between the first end 54 and the second end 56.

The inner surface 58 and the outer surface may be at least partially disposed around a third axis A3. In an assembled configuration, the third axis A3 may be coaxial with the first and second axes A1, A2. In some implementations, the second endcap 18 is substantially “U”-shaped. The second endcap 18 may include a manipulation feature 62 may include a projection extending from the outer surface 60 and configured for manipulation (e.g., by the tool 20 or another tool or person) during installation of the wiring harness installation assembly 10.

As illustrated in FIG. 1, the second endcap 18 may engage the second end 24 of the sleeve 14. For example, the first end 54 of the second endcap 18 may engage the second end 24 of the sleeve 14 and the inner surface 58 of the second endcap 18 may engage the second surface 28 of the sleeve 14. In some implementations, the second endcap 18 is secured to the second end 24 of the sleeve 14 using an adhesive.

The second endcap 18 may include a set of third fingers 64 disposed around and extending from the first end 54 of the second endcap 18. The set of third fingers 64 may extend towards the third axis A3. The set of third fingers 64 may allow the wiring harness 12 to pass through the second endcap 18 and into the sleeve 14, while helping to secure the wiring harness 12 inside the sleeve 14 and the second endcap 18.

The second endcap 18 may define an opening 66. The opening 66 may be at least partially defined by the inner surface 58 and/or the set of third fingers 64. The opening 66 may be disposed (e.g., circumferentially-disposed) around the third axis A3. In the assembled configuration, the wiring harness 12 may be disposed within the opening 66.

The size of the second endcap 18 may be dependent on the size of the wiring harness 12. The second endcap 18 may be plastic, such as ABS or PVC, or any other suitable material. While the second endcap 18 is generally shown and described as engaging the second end 24 of the sleeve 14, the second endcap 18 may engage the first end 22 of the sleeve 14 within the scope of the present disclosure.

Various example embodiments of the invention are described in the following clauses.

Clause 1: An end cap for a wiring harness installation sleeve, the end cap comprising: a base disposed around a central axis and including a first end and a second end opposite the first end; a first portion extending from the first end and disposed about the central axis, the first portion including an outer surface; and a second portion extending from the first end and disposed about the central axis, the second portion including an inner surface, the inner surface and the outer surface defining a gap configured to receive the wiring harness installation sleeve.

Clause 2: A wiring harness installation assembly comprising: the end cap of clause 1; and a sleeve, wherein the inner surface engages the sleeve.

Clause 3: The wiring harness installation assembly of clause 2, wherein the outer surface engages the sleeve.

Clause 4: The wiring harness installation assembly of any of clauses 2 through 3, wherein the sleeve is disposed within the gap.

Clause 5: The wiring harness installation assembly of any of clauses 2 through 4, further comprising: a second end cap, wherein: the sleeve includes a first end and a second end opposite the first end, the end cap is configured to engage the first end of the sleeve, and the second end cap is configured to engage the second end of the sleeve.

Clause 6: The end cap of any of clauses 1 through 5, further comprising a robotic installation feature extending from the base.

Clause 7: The end cap of clause 6, wherein the robotic installation feature extends from the second end of the base.

Clause 8: The end cap of any of clauses 1 through 7, wherein the first portion is parallel to the second portion.

Clause 9: The end cap of any of clauses 1 through 8, wherein the base defines a semi-spherical shape.

Clause 10: The end cap of any of clauses 1 through 9, wherein: the first portion includes a set of first fingers, and the second portion includes a set of second fingers.

Clause 11: A wiring harness installation sleeve comprising: a first surface extending from a first end of the sleeve to a second end of the sleeve; and a second surface opposite the first surface and extending from the first end to the second end, the second surface defining at least one recess disposed between the first end and the second end and configured to facilitate bending the sleeve in a first direction.

Clause 12: The wiring harness installation sleeve of clause 11, wherein the first surface and the second surface collectively define a hollow cylinder configured to receive a wiring harness.

Clause 13: The wiring harness installation sleeve of any of clauses 11 through 12, wherein the at least one recess extends through the first surface.

Clause 14: The wiring harness installation sleeve of any of clauses 11 through 13, wherein the at least one recess includes a plurality of recesses collectively surrounding the sleeve.

Clause 15: The wiring harness installation sleeve of clause 14, wherein the plurality of recesses is equally spaced around at least a portion of the sleeve.

Clause 16: The wiring harness installation sleeve of any of clauses 11 through 15, wherein each recess of the at least one recess has a diamond shape.

Clause 17: A wiring harness installation assembly comprising: the sleeve of clause 11; and an endcap coupled to the first end of the sleeve.

Clause 18: The wiring harness installation assembly of clause 17, wherein the endcap includes: a base disposed around a central axis and including a first end and a second end opposite the first end; a first portion extending from the first end and disposed about the central axis, the first portion including an outer surface; and a second portion extending from the first end and disposed about the central axis, the second portion including an inner surface, the inner surface and the outer surface defining a gap configured to receive the sleeve.

Clause 19: The wiring harness installation assembly of clause 18, wherein the inner surface engages the sleeve.

Clause 20: The wiring harness installation assembly of any of clauses 17 through 19, further comprising a second endcap coupled to the second end of the sleeve and defining an opening configured to receive a wiring harness.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. An end cap for a wiring harness installation sleeve, the end cap comprising:
a base disposed around a central axis and including a first end and a second end opposite the first end;
a first portion extending from the first end and disposed about the central axis, the first portion including an outer surface; and
a second portion extending from the first end and disposed about the central axis, the second portion including an inner surface, the inner surface and the outer surface defining a gap configured to receive the wiring harness installation sleeve.

2. A wiring harness installation assembly comprising:
the end cap of claim 1; and
a sleeve, wherein the inner surface engages the sleeve.

3. The wiring harness installation assembly of claim 2, wherein the outer surface engages the sleeve.

4. The wiring harness installation assembly of claim 2, wherein the sleeve is disposed within the gap.

5. The wiring harness installation assembly of claim 2, further comprising:
a second end cap, wherein:
the sleeve includes a first end and a second end opposite the first end, the end cap is configured to engage the first end of the sleeve, and the second end cap is configured to engage the second end of the sleeve.

6. The end cap of claim 1, further comprising a robotic installation feature extending from the base.

7. The end cap of claim 6, wherein the robotic installation feature extends from the second end of the base.

8. The end cap of claim 1, wherein the first portion is parallel to the second portion.

9. The end cap of claim 1, wherein the base defines a semi-spherical shape.

10. The end cap of claim 1, wherein:
the first portion includes a set of first fingers, and
the second portion includes a set of second fingers.

11. A wiring harness installation sleeve comprising:
a first surface extending from a first end of the sleeve to a second end of the sleeve; and
a second surface opposite the first surface and extending from the first end to the second end, the second surface defining at least one recess disposed between the first end and the second end and configured to facilitate bending the sleeve in a first direction.

12. The wiring harness installation sleeve of claim 11, wherein the first surface and the second surface collectively define a hollow cylinder configured to receive a wiring harness.

13. The wiring harness installation sleeve of claim 11, wherein the at least one recess extends through the first surface.

14. The wiring harness installation sleeve of claim 11, wherein the at least one recess includes a plurality of recesses collectively surrounding the sleeve.

15. The wiring harness installation sleeve of claim 14, wherein the plurality of recesses is equally spaced around at least a portion of the sleeve.

16. The wiring harness installation sleeve of claim 11, wherein each recess of the at least one recess has a diamond shape.

17. A wiring harness installation assembly comprising:
the sleeve of claim 11; and
an endcap coupled to the first end of the sleeve.

18. The wiring harness installation assembly of claim 17, wherein the endcap includes:
a base disposed around a central axis and including a first end and a second end opposite the first end;
a first portion extending from the first end and disposed about the central axis, the first portion including an outer surface; and
a second portion extending from the first end and disposed about the central axis, the second portion including an inner surface, the inner surface and the outer surface defining a gap configured to receive the sleeve.

19. The wiring harness installation assembly of claim 18, wherein the inner surface engages the sleeve.

20. The wiring harness installation assembly of claim 17, further comprising a second endcap coupled to the second end of the sleeve and defining an opening configured to receive a wiring harness.
